(19) United States
(12) Patent Application Publication
(10) Pub. No.: US 2003/0167801 A1
(43) Pub. Date: Sep. 11, 2003

(54) Method for producing a full cylinder from quartz glass

(76) Inventors: Thomas Bogdahn, Karlstein (DE); Oliver Ganz, Bruchkoebel (DE); Harald Hain, Kahl (DE)

Correspondence Address: Connolly Bove Lodge & Hutz, P O Box 2207, Wilmington, DE, 19899-2207, US

(21) Appl. No.: 10/297,240

(22) PCT Filed: May 19, 2001
(86) PCT No.: PCT/EP01/05763

(30) Foreign Application Priority Data
Jun. 6, 2000 (DE) 100 28 164.8
Apr. 27, 2001 (DE) 101 20 817.0

(51) Int. Cl. C03B 37/10

(52) U.S. Cl. 65/428

(57) ABSTRACT

In a known method for the manufacture of a solid quartz glass cylinder (18) by drawing from a hollow quartz glass cylinder (5) in a vertical drawing process, the hollow cylinder (5) is passed to a heating zone (4), softened therein in one area after the other and the solid cylinder (18) is drawn off from the softened area (15) with a reduced inside pressure (P₁) being maintained in the inside bore (19) of the hollow cylinder (5) versus an outside pressure (P₂) applied on the outside thereof. To be able to specify on this basis a method by means of which a solid quartz glass cylinder can be inexpensively drawn from a hollow cylinder by largely avoiding a radial deformation, it is proposed in accordance with the invention that the vertical drawing process comprises an initial drawing phase and a drawing phase, with the inside pressure (P₁) being gradually reduced in the course of the initial drawing phase, by 10 mbar per minute or slower, down to a preset nominal value, and the inside bore being collapsed at the same time.

This invention concerns a method for manufacturing a solid quartz glass cylinder by drawing from a hollow quartz glass cylinder in a vertical drawing process in which the hollow cylinder is passed to a heating zone, is softened therein by one area after the other and the solid cylinder drawn off from the softened area, with an internal pressure being maintained in the hollow cylinder's inside bore, this pressure being lower compared to an external pressure applied on the outside thereof.

From U.S. Pat. No. 4,772,303, a method is known for manufacturing an optical fiber by drawing from a hollow quartz glass cylindrical preform. During the fiber drawing process, the preform is passed—in vertical orientation and beginning with its bottom end—into a drawing furnace; it is softened therein and from the preform's softened area, the fiber is drawn by forming a drawing bulb. A specified under-pressure is maintained in the inside bore.

Due to the under-pressure in the inside bore, forces in the softened area are acting toward the inside which can result in a radial deformation during the collapsing process such that the preform's radial symmetry and the fiber drawn therefrom will be lost and the fiber is rendered unusable. To avoid this, U.S. Pat. No. 4,772,303 proposes to work with the smallest possible under-pressure in the inside bore—the mentioned optimum being an under-pressure in the range of between 0 and 22 mmWS (millimeter water column; equivalent to 0 to 2.2 mbar). Moreover, it is mentioned that an inside bore with a small internal diameter is easier to collapse without deformation.

Due to the small under-pressure, the known method requires long processing periods and thus is expensive.

The invention is based on the task of specifying a method by means of which a solid quartz glass cylinder can be inexpensively drawn from a hollow cylinder by largely avoiding any radial deformation.

Based on the above-mentioned method, this task is solved in accordance with the invention by the vertical drawing process comprising an initial drawing phase and a drawing phase, with the inside pressure (P₁) gradually being reduced in the course of the initial drawing phase—by 10 mbar per minute or slower—down to a specified nominal value and the inside bore being collapsed at the same time.

The vertical drawing process comprises an initial drawing phase and the actual drawing phase. During the initial drawing phase, the hollow cylinder's inside bore narrows gradually. The initial drawing phase is especially critical in view of a radially asymmetrical deformation. A deformation which is pronounced in the initial drawing phase cannot be remedied or not completely remedied during the further drawing process.

According to the invention, the inside pressure is reduced gradually during the initial drawing phase—by 10 mbar per minute or slower. Thus, a suction pump connected with the inside bore is not operated from the start at the suction capacity which is required for adjusting the nominal under-pressure value during the drawing phase, but the suction pump's capacity is increased gradually from a low value during the initial drawing phase up to the adjustment of the necessary nominal under-pressure value. It has been shown that this will prevent a radial deformation of the inside bore in the softened area. Only when the critical phase has been exceeded with regard to the deformation, the suction pump's capacity is adjusted such that the inside pressure reaches the specified nominal value.

Thus can also be achieved that a comparatively low inside pressure is adjusted (high under-pressure) during the actual drawing phase—without radial deformations of the hollow cylinder. The lower inside pressure, in turn, enables faster collapsing of the inside bore during the drawing phase and thus an acceleration of the drawing process.

“Under-pressure” is defined as the absolute amount of the pressure difference between the outside pressure being applied in the area of the softened zone outside of the inside bore and between the pressure in the inside bore (inside pressure). In the simplest case, but not necessarily, the outside pressure is equivalent to atmospheric pressure. Since the inside pressure is lower than the outside pressure, the under-pressure values have a positive sign. Within the sense of this definition, a reduction of the inside pressure thus is equivalent to an increase of the under-pressure.

The “gradual” reduction of the inside pressure during the initial drawing phase is approximately steadily. Ideally, the inside pressure is continuously reduced, with a reduction in small individual steps not being detrimental for the technical success of the teachings according to the invention. The statement of a reduction of the inside pressure as “by 10 mbar per minute or slower” is understood as a mean value within a period of time in which the inside pressure is reduced.

The initial drawing phase is completed as soon as the hollow cylinder's inside bore is completely collapsed. The phase of gradual reduction of the inside pressure advantageously extends beyond the end of the initial drawing phase. Because temperature variations in the furnace or dimensional deviations of the quartz glass hollow cylinder may result in an under-pressure—still having been sufficient for closing the inside bore—which subsequently will not be sufficient to maintain the collapse of the inside bore. To prevent opening of the already collapsed inside bore, the inside pressure is thus, for safety's sake, still lowered even further after the inside bore is closed.

In the event that the phase of the inside pressure's gradual reduction is already terminated before the final collapse of the inside bore and the nominal under-pressure value is adjusted thereupon, the remaining inside bore should be so stable that its “residual diameter” can be collapsed without radial deformation. Aside from the inside bore's “residual diameter”, this will essentially depend upon the hollow cylinder's wall thickness and upon the under-pressure.

The “nominal value” of the inside pressure is understood to mean an absolute value for the pressure in the inside bore which is to be adjusted during the actual drawing phase. The under-pressure is not generally constant during the drawing phase. In a controlled drawing process, the standard measure is customarily the outside diameter of the drawn-off solid cylinder. The required under-pressure depends, among other things, on the hollow cylinder's geometry and on the quartz glass viscosity in the softened area. The lower the viscosity, the smaller the required under-pressure.

Advantageously, the inside pressure is reduced at least during a time period prior to the complete closing of the inside bore, as a function of the remaining residual diameter of the inside bore. The inside bore will gradually close during the initial drawing phase. The residual diameter is determined by the inside bore's minimum width of opening. The smaller the residual diameter, the smaller the risk of radial deformations. Thus, the under-pressure in the inside bore may be the higher, the smaller the residual diameter. Due to a reduction of the inside pressure—taking the residual diameter into account—the drawing process can be further accelerated.

It has proved well to reduce the inside pressure such that the nominal value will only be reached when the inside bore has a residual diameter of 4 mm or less, advantageously 2 mm or less. For an inside bore with a residual diameter of the specified size, the risk of deformation during the remaining collapsing will be negligible. Thus, subject to the specified maximum values for the residual diameter, the nominal inside pressure value can thus be adjusted already prior to the conclusion of the initial drawing phase and the drawing process can thus be accelerated overall. As already mentioned, the specified maximum values for the residual diameter essentially depend upon the absolute value of the under-pressure and upon the hollow cylinder's wall thickness.

It proved to be expedient to reduce the inside pressure slowly—in the course of the initial drawing phase—that means in the area of 1 mbar per minute and 5mbar per minute, advantageously in the area of 1.5 mbar per minute and 3 mbar per minute. Slow reduction of the inside pressure reduces the risk of radial deformations of the hollow cylinder. The specified values for the rate of reduction are understood as mean values for a time interval between the beginning of the inside pressure reduction and reaching the nominal value.

In a preferred embodiment of the method according to the invention, the nominal inside pressure value is specified as a default such that an under-pressure of at least 40 mbar will adjust itself in the inside bore, advantageously of at least 50 mbar and particularly advantageously of at least 70 mbar. Due to the comparatively high under-pressure, the inside bore's collapsing in the softened area will be accelerated—and thus also the entire drawing process. It is precisely the method according to the invention which enables the adjustment of such high under-pressure during the drawing phase without the hollow cylinder's radial deformation.

It proved to be advantageous that a controlled flow of gas is passed to the inside bore during the drawing phase, with the inside pressure being maintained by means of a suction pump. Introduction of the flow of gas facilitates the inside pressure's regulation to the specified nominal value. An inert gas—such as nitrogen—is particularly suitable as the flow of gas.

The method according to the invention has proved particularly well in the application of a thick-walled hollow cylinder with an outside diameter of more than 50 mm and a ratio of outside diameter and inside diameter of at least 2.0. The process times required for the collapsing of such thick-walled hollow cylinders will be significantly shortened due to the method according to the invention so that the method enables the processing of a large mass of quartz glass in the form of solid cylinders. In view thereof, it proves to be particularly advantageous to use a hollow cylinder of an outside diameter of more than 100 mm, as the starting material for the process, with a ratio of 2.5 or larger for outside diameter and inside diameter.

The method according to the invention is particularly suitable for the inexpensive manufacture of a solid cylinder for the production of an optical waveguide by using a hollow cylinder of a high-purity synthetic quartz glass.

Hereinafter, the method according to the invention will be explained in more detail on the basis of embodiments and one drawing. The only figure of the drawing shows

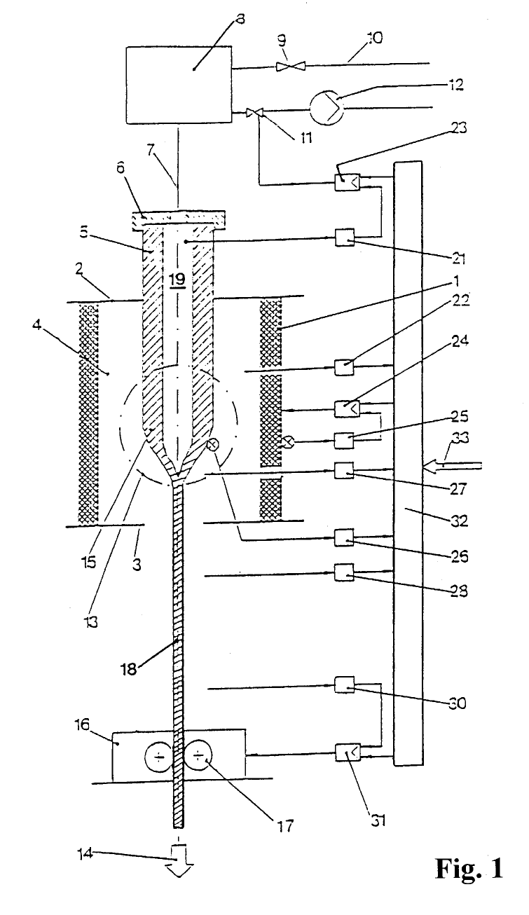

FIG. 1 a device for the implementation of the method according to the invention in diagrammatic presentation.

The device shown in FIG. 1 comprises a vertically arranged furnace 1 with a top furnace entry 2 and a bottom furnace exit 3. The interior heating chamber 4 of furnace 1 is heatable to temperatures of up to above 2,300° C.

A hollow quartz glass cylinder 5 is introduced into the furnace chamber 4 which is closed on its top by a support 6. For this, a guiding device (not presented in the figure) contacts on the top of the hollow cylinder. Hollow cylinder 5 is closed by a support 6 on its top end and connected—via a supply line 7—with a process vessel 8 which is connected on the one hand with nitrogen supply 10 via a shutoff valve 9 and on the other hand with a vacuum pump 12 via a regulating valve 11.

Hollow cylinder 5 is softened in the area of a deformation zone 13—approx. in the middle of the furnace chamber 4. From the softened area, a rod 18 is drawn off in direction of the arrow 14 by means of a drawoff 16. To this end, drawoff 16 is provided with guide rolls 17 which contact the circumference of the rod. A drawing bulb 15 is formed and, at the same time, the inside bore 19 of hollow cylinder 5 collapses. A vacuum pump 12 is used for generating an under-pressure within the inside bore 19; the pump—via a support 6—acting upon the top end of the hollow cylinder 5.

During the drawing process, the pressure conditions in the furnace chamber 4 as well as in the inside bore 19 can be definably adjusted and changed. To this end, a pressure gauge 21 is provided for monitoring the pressure in inside bore 19, as well as another pressure gauge 22 for measuring the pressure in furnace chamber 4. Moreover provided are a pressure regulator 23 which controls the regulating valve 11, a temperature regulator 24 for controlling the furnace temperature, a pyrometer 25 for measuring and monitoring the set furnace temperature, another pyrometer 26 for measuring the temperature in the area of the drawing bulb 15, a diameter gauge 27 for measuring the diameter of the drawn-off rod 18 immediately after the drawing bulb 15, i.e. within the furnace chamber 4, another diameter gauge 28 for measuring the diameter of the drawn-off rod 18 outside of furnace 1, a velocity gauge 30 for measuring the drawing speed of rod 18 in direction of arrow 14, as well as a speed controller 31 which controls the drawoff 16 and thus adjusts the speed of rotation of the guide rolls 17. All regulators, gauges and other equipment, such as are indicated above, are connected to a central process regulating and control system 32. Nominal values—for example for the diameter of rod 18, the required mass throughput, etc.—are entered via the central process regulating and control system, as indicated by the input arrow 33.

As can be seen on the basis of the numerous measuring and control systems as well as the other monitoring equipment, the drawing process for the manufacture of rod 18 with the desired outside diameter can be continuously monitored and newly set up or, respectively, adjusted to the conditions.

Hereinafter, typical examples are described in detail regarding the manufacture of a rod 18 by means of the method according to the invention and by using the device presented in FIG. 1:

The process for drawing rod 18 from the hollow cylinder 5 comprises an initial drawing phase and the actual drawing phase. During the initial drawing phase, inside bore 19 is not yet entirely closed. To produce and maintain a defined under-pressure in the inside bore 19, it is thus advantageous to keep the bottom open end of hollow cylinder 5 closed during the initial drawing phase by means of a seal, such as a silicone plug. Process vessel 8 serves as a buffer to reduce any possible pressure variations.

### EXAMPLE 1

As a first typical example, a rod 18 with an outside diameter of 33 mm is drawn—with the device according to FIG. 1—from a hollow cylinder 5 with an outside diameter of 165 mm and an inside diameter of 55 mm.

A temperature of 2,300° C. is set in furnace chamber 4. During the drawing process, pressure P₂ amounts to 1100 mbar in heating chamber 4. During the initial drawing phase, the inside pressure P₁ in inside bore 19 is gradually reduced from an initial pressure of also 1100 mbar to a nominal pressure of 1040 mbar; thus, the under-pressure in the inside bore 19 is 60 mbar. This under-pressure is built up during a pressure building phase of 30 minute duration, at a rate of 2 mbar/min. During that time, the inside bore 19 of hollow cylinder 5 narrows. At the end of the pressure buildup phase and upon reaching the nominal pressure of 1040 mbar, the inside bore still has a width of opening of 2 mm. During the further drawing process, a constant outside diameter of rod 18 is regulated by using the inside pressure P₁ within inside bore 19 as the setting value.

### EXAMPLE 2

In another typical example, a rod 18 with an outside diameter of 25 mm is drawn—with the device according to FIG. 1—from a synthetic quartz glass hollow cylinder 5 with an outside diameter of 100 mm and an inside diameter of 38 mm.

A temperature of 2,300° C. is set in furnace chamber 4. During the drawing process, pressure P₂ amounts to 1100 mbar in heating chamber 4. During the initial drawing phase, the inside pressure P₁ in inside bore 19 is gradually reduced from an initial pressure of 1100 mbar to a nominal pressure of 1048 mbar; the under-pressure in the inside bore 19 thus is 52 mbar.

This under-pressure is built up during a period of time prior to the complete closing of inside bore 19. To this end, the remaining residual diameter of inside bore 19 is continuously measured and, as a function thereof, the under-pressure is increased in steps. In the concrete case, the following function results between under-pressure and residual diameter of the inside bore: With every reduction of the residual diameter of approx. 1.5, the under-pressure is increased stepwise by 2 mbar. At a residual diameter of 3 mm, the above indicated nominal pressure is reached. In this case, the duration of the pressure buildup phase is approx. 35 minutes while the under-pressure is built up with a mean value in time, at a rate of approx. 1.5 mbar/min. In the further drawing process, a constant outside diameter of rod 18 is regulated with the inside pressure P₁ being continuously adjusted within inside bore 19. To enable control—in case of an excessive under-pressure—toward a reduction of the under-pressure, a flow of nitrogen of approx. 5 l/min. is passed into the inside bore 19 via nitrogen supply line 10.

The solid rod thus obtained is cut into suitable partial lengths and used for the manufacture of a preform for optical fibers.

1. A method for the manufacture of a solid quartz glass cylinder (18) by drawing in a vertical drawing process from a hollow quartz glass cylinder (5), in which the hollow cylinder (5) is passed to a heating zone (4), is softened therein by one area after the other and the solid cylinder (18) being drawn off from the softened area (15), with an inside pressure (P₁) being maintained in the inside bore (19) of the hollow cylinder (5) which inside pressure is reduced versus an outside pressure (P₂ ) applying on the outside thereof, characterized in that the vertical drawing process comprises an initial drawing phase and a drawing phase, with the inside pressure (P₁) being gradually reduced within the course of the initial drawing phase, by 10 mbar per minute or slower, down to a preset nominal value and the inside bore being collapsed at the same time.

2. A method according to claim 1, characterized in that inside pressure (P₁) is reduced at least during a period of time prior to the complete closing of inside bore (19) as a function of a remaining residual diameter of the inside bore (19).

3. A method according to claim 1 or 2, characterized in that inside pressure (P₁) is reduced such that the nominal value is only reached when inside bore (19) shows a residual diameter of 4 mm or less.

4. A method according to claim 3, characterized in that the nominal value is reached only when the inside bore (19) shows a residual diameter of 2 mm or less.

5. A method according to claim 1, characterized in that the inside pressure (P₁) is reduced in the area of 1 mbar per minute to 5 mbar per minute.

6. A method according to claim 5, characterized in that the inside pressure (P₁) is reduced in the area of 1.5 mbar per minute to 3 mbar per minute.

7. A method according to claim 1, characterized in that the nominal value of inside pressure (P₁) is specified such that an under-pressure of at least 40 mbar will be adjusted in the inside bore (19).

8. A method according to claim 7, characterized in that the nominal value of inside pressure (P₁) is specified such that an under-pressure of at least 50 mbar will adjust itself in inside bore (19).

9. A method according to claim 7, characterized in that an under-pressure of at least 70 mbar will adjust itself in inside bore (19).

10. A method according to claim 1, characterized in that a flow of gas (10) can be passed in a controlled fashion to the inside bore (19) during the drawing phase and that inside pressure (P₁) is maintained by means of a suction pump (12).

11. A method according to claim 1, characterized in that a thick-walled hollow cylinder (5) is used with an outside diameter of more than 50 mm and a ratio of at least 2.0 for outside diameter and inside diameter.

12. A method according to claim 11, characterized in that a hollow cylinder (5) is used with an outside diameter of more than 100 mm and a ratio of 2.5 or larger for outside diameter and inside diameter.

13. A method according to claim 1, characterized in that a hollow cylinder (5) of a high-purity synthetic quartz glass is used for the manufacture of a solid cylinder (18) for the production of an optical waveguide.
